(19) United States
(12) Patent Application Publication
(10) Pub. No.: US 2026/0142208 A1
(43) Pub. Date: May 21, 2026

(54) MICROBIAL FUEL CELL MULTIPLEXER APPARATUS, SYSTEM AND METHOD

(71) Applicant: The United States of America as represented by the Secretary of the Navy, Arlington, VA (US)

(72) Inventors: Eric Bozeman, San Diego, CA (US); Matthew Bond, San Diego, CA (US); Yolanda Meriah Arias-Thode, San Diego, CA (US); Halah Ramzi, El Cajon, CA (US); Taneka Lewis, San Diego, CA (US); Gregory Anderson, San Diego, CA (US)

(73) Assignee: The United States of America as represented by the Secretary of the Navy, Arlington, VA (US)

(21) Appl. No.: 18/955,527

(22) Filed: Nov. 21, 2024

(51) Int. Cl. H01M 8/04992; H01M 8/04858; H01M 8/04955; H01M 8/16

(52) U.S. Cl. CPC H01M 8/04992; H01M 8/04873; H01M 8/04955; H01M 8/16

(57) ABSTRACT

A microbial fuel cell multiplexer apparatus, system and method. In one embodiment, a microbial fuel cell (MFC) multiplexer, comprising a microcontroller suitable for receiving information from a MFC electronics unit and reformatting the information according to a communications protocol, and further comprising a processor and a non-transitory storage medium capable of storing machine-readable instructions; a host port connected to a host platform, wherein the host platform provides a power source and an operating terminal; a plurality of isolator chips, electrically connected to the microcontroller, designed to isolate a plurality of MFCs; and a plurality of unit ports each arranged to connect each of the plurality of isolator chips to one of the plurality of MFCs.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: NIWC_Pacific_T2@us.navy.mil, referencing Navy Case No. 211,374.

### BACKGROUND

Improvements in microbial fuel cell (MFC) technology have enabled bio-electrochemical energy capture by converting chemical energy stored in organic compounds directly to electrical energy. MFCs may be used in ocean, river, and lake environments to harvest energy from the microbial life of the sea floor. Furthermore, the field has progressed into developing support systems for MFCs in these environments. An MFC unit is typically accompanied by an adjacent or proximally adjacent MFC electronics units that can store energy and log the performance of an MFC unit. It is important to be able to control, measure, and assess the energy capture of MFCs to determine the amount of energy harvest or the rate of harvest, as two examples of important metrics. These support systems have complex operational requirements due to the aquatic environment and unique characteristics of microbial fuel cell technology.

With the success of microbial fuel cells, there is a need to develop ways to integrate and manage systems of microbial fuel cell units that are suitable for the unique constraints of the underwater environment.

### SUMMARY

According to illustrative embodiments, a microbial fuel cell (MFC) multiplexer, comprising a microcontroller suitable for receiving information from a MFC electronics unit and reformatting the information according to a communications protocol, and further comprising a processor and a non-transitory storage medium capable of storing machine-readable instructions; a host port connected to a host platform, wherein the host platform provides a power source and an operating terminal; a plurality of isolator chips, electrically connected to the microcontroller, designed to isolate a plurality of MFCs; and a plurality of unit ports each arranged to connect each of the plurality of isolator chips to one of the plurality of MFCs.

In some embodiments, an integrated microbial fuel cell (MFC) and multiplexer system, comprising a plurality of microbial fuel cells (MFCs); a plurality of MFC electronics units electrically connected to at least one of the plurality of MFCs; a MFC multiplexer connected to each of the plurality of MFC electronics units, further comprising: a microcontroller suitable for receiving information from at least one MFC electronics unit and reformatting the information according to a communications protocol, and further comprising a processor and a non-transitory storage medium capable of storing machine-readable instructions; a host port connected to a host platform, wherein the host platform provides a power source and an operating terminal; a plurality of isolator chips, electrically connected to the microcontroller, designed to isolate a plurality of MFCs; and a plurality of unit ports each arranged to connect each of the plurality of isolator chips to one of the plurality of MFCs.

And, in some embodiments, a method for integrating a microbial fuel cell system having a MFC multiplexer, the steps comprising receiving ascension information to the MFC multiplexer; transmitting a data request to each of a plurality of MFC electronics units; receiving MFC data at the MFC multiplexer; reformatting the MFC data to a communications protocol with the user configured baud rate; storing MFC data in a non-transitory storage medium; initiating a sleep state for the MFC multiplexer; receiving surfacing information; transmitting the MFC data to a host; transmitting a clear data command and a clock synchronization command to each of a plurality of MFC electronics units; and reinitiating a logging protocol at each of the plurality of MFCs.

It is an object to provide a Microbial Fuel Cell Multiplexer Apparatus, System, and Method that offers numerous benefits, including providing a solution for integration a plurality of MFC energy harvesting systems.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1A illustrates some embodiments of a MFC Multiplexer in an operational environment.

FIG. 1B illustrates some embodiments of a MFC Multiplexer in an operational environment.

FIG. 1C illustrates some embodiments of a MFC Multiplexer in an operational environment.

FIG. 2 illustrates an exemplary printed circuit board for a MFC Multiplexer.

FIG. 3 illustrates a second exemplary printed circuit board for a MFC Multiplexer.

FIG. 4 shows a block-diagram illustration of a method for integrating a microbial fuel cell system having a MFC multiplexer.

### DETAILED DESCRIPTION OF EMBODIMENTS

The disclosed apparatus, system, and method below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other apparatus, system, and method described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

While testing and evaluating microbial fuel cells, the inventors noticed several limitations of existing technology for integrating diagnostic information of energy harvester. The integration of disparate sampling systems was not possible. Based on this experience, the inventors discovered a MFC multiplexer could manage data integration and communication between MFC sampling systems. The inventors further discovered that the MFC multiplexer could properly format the data and provide their data to a platform through its single port, which will allow for performance evaluation while the MFCs are in operation.

Testing and evaluation of a prototype MFC multiplexer demonstrated that disparate sampling system may be combined to provide data to a platform. In one embodiment, a platform such as the MRV Alto™, which has the ability to sit on the seafloor and surface to offload data, may utilize a MFC multiplexer to integrate sampling systems. It is beneficial for the platform to receive information including MFC diagnostics, sampling data, and energy harvest rates, as some examples. Further testing and evaluation caused the inventors to realize the MFC multiplexer enables the integration of a plurality of MFC energy harvest systems directly with on-shore platforms. Minimizing the necessary hardware and cables to support MFC harvesters supports deployment to more locations while also being more discrete. The prototype MFC multiplexer was shown to integrate a plurality of MFC energy harvest systems, while keeping the energy harvest systems safely isolated.

Further testing and evaluation of a prototype MFC multiplexer demonstrated another benefit of MFC multiplexers. MFC multiplexers allow multiple MFC energy harvesters to communicate and be controlled from a single port while, critically, remaining electrically isolated in a submerged environment. This is important for any platform with limited communication ports or for ease of use while deployed near the shore. It also allows the individual MFC units to remain isolated while communicating with a host computer/system. With current technology, MFC units are not isolated because, even when plugged into separate ports, they still share a common ground. That common ground that is, typically, water. When water is used as a common ground, there is a risk of electrical interferences between the systems. Therefore, there is significant advantage in keeping the system isolated. The host computer may typically include a variety of non-transitory computer readable media. By way of example, and not limitation, computer readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device. Computer storage media does not, however, include propagated signals. Rather, computer storage media excludes propagated signals. Any such computer storage media may be part of computing device.

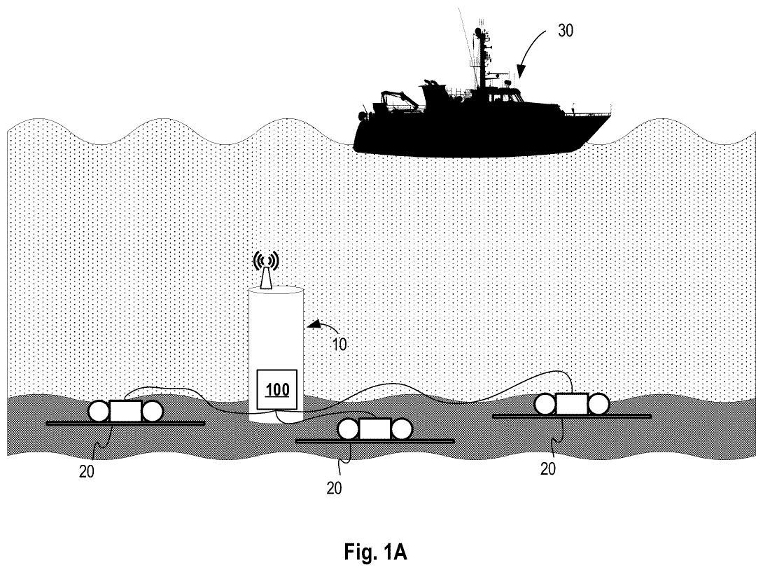

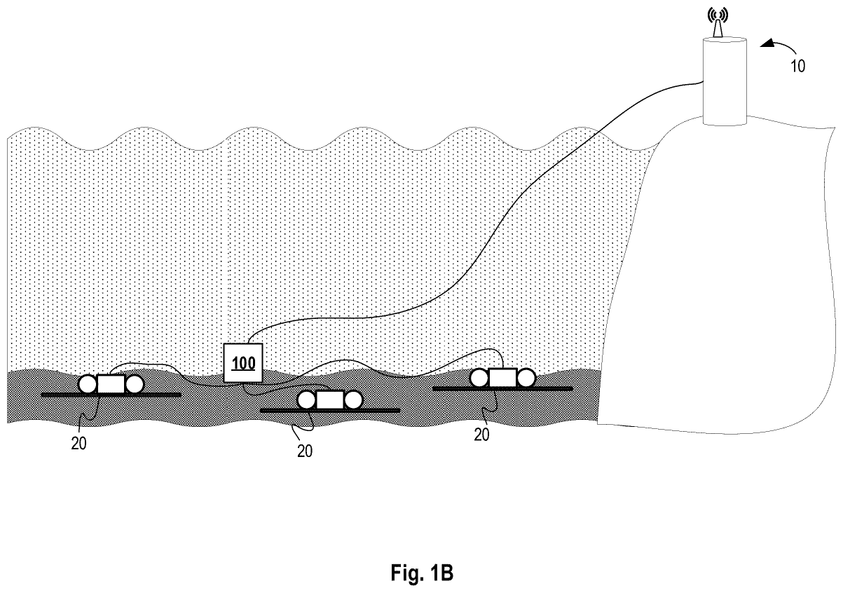

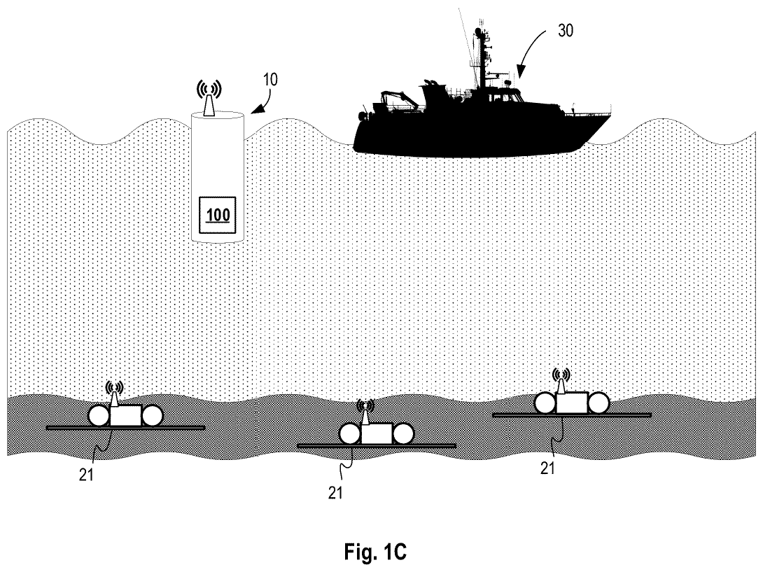

FIG. 1A illustrates an exemplary use environment for a MFC Multiplexer 100 comprising a platform 10, a plurality of energy harvesters 20, and aquatic vessel 30. The platform 10 may include a sensor system such as the MRV Alto™. This platform 10 may sit on the seafloor (or other aquatic bed) while information is being sensed and logged, and then resurface to upload data to the host. In this embodiment, the MFC Multiplexer 100 is coupled to the platform 10 and is electrically connected (via a cable) to the plurality energy harvesters 20. Additionally, the platform 10 is submerged alongside the plurality of harvesters, as shown. Finally, the platform 10 is shown to comprise a wireless transmitting for communicating with a base, vessel, or the link. In another embodiment, the platform 10 may be connected to a base or vessel directly with a cable. Moreover, MFC Multiplexer 100 is designed to withstand the environmental conditions that the sensor system may be subject to including, but not limited to, salt water, fresh water, currents, and temperature changes.

In some embodiments, the platform 10 may be a MRV Alto™ or similar sensor system. These platforms 10 typically have predefined baud rates that require the MFC multiplexer 100 to match that rate. The MFC multiplexer 100 may be configured by a user to match the baud rates of the platform 10.

Platforms 10 have the functional ability to ascend and descend in the water, in some embodiments. An exemplary use method of using a MFC multiplexer may be the following process. To being, a host starts communicating by telling the MFC Multiplexer 100 that it has started ascending. The MFC Multiplexer 100 then sends commands to request data from each of the connected MFC units 20. As data from each unit arrives to the MFC Multiplexer 100, it is re-formatted to conform the platform's data requirements. The MFC Multiplexer 100 may temporarily store the data from all three units on its non-transitory memory and puts the MFC units into a sleep state until they need to start logging again. Once the host tells the MFC Mux that it has surfaced, the MFC Mux transmits the data to the master in the correct format. The platform then transmits the data wirelessly to the users. When the platform has reached the sea floor again, it tells the MFC mux that it has parked. Then the MFC Mux sends commands to the individual MFC units to clear the old data from memory resets the clocks on the MFC units to synchronize the time between them. After that, the MFC Mux starts the individual units logging again.

The plurality of energy harvesters 20 are microbial fuel cells that utilize bio-electrochemical energy capture to convert chemical energy into electrical energy. These harvesters 20 may rest on a seafloor, lake bed, or riverbed to access the potential energy stored in the aquatic microbes. Each MFC harvester may be coupled or approximately adjacent to an MFC electronics unit. The MFC electronics unit may be configured to receive, store, transmit, configure, assess, log, and/or communicate MFC data. MFC data is information associated with the harvesting of energy, including the amount of energy harvested, the rate of energy harvesting, and harvester status data. The aquatic vessel 30 is shown in FIG. 1 to convey one exemplary use case where the platform 20 may be accessed or communicated with via host by a user/operator.

The MFC multiplexer 100 may receive state information from the platform including ascension, dissention, and its vertical position from the aquatic bed to the surface. Additionally, state information may comprise data collection states, status states, and transmission states for data uploads. By implementing status states in the MFC multiplexer, precious energy stores may be conserved.

A user may have complete control over MFC energy harvesters 20 via the MFC multiplexer 100. The user may select the data to be formatted differently, set the time, retrieve/delete data and even change the baud rate. In some embodiments, it may be more convenient to use a simple serial port terminal on a laptop as the host. In that case, all of the commands to the MFC multiplexer 100 may be human-readable, so the system can be fully controlled via the terminal.

FIG. 1B shows an exemplary illustration of a second embodiment for a MFC Multiplexer 100 comprising a platform 10, a plurality of energy harvesters 20, wherein the platform 10 is located on-shore. As shown in FIGS. 1A and 1B, the MFC multiplexer 100 may be used with different host systems. In this embodiment, the platform 10 is located on shore and is directly connected to the MFC multiplexer 100 via a cable. In another embodiment, the platform 10 may be wirelessly connected to the MFC multiplexer 100, wherein the MFC multiplexer 100 comprises a transmitter/receiver module.

In some embodiments, multiple host platforms could also be used. The microcontroller 201 of the MFC multiplexer 100 may be programmed to communicate at the correct rate and present the data in the correct format for a plurality of hosts. With the proper wireless transceiver, the MFC multiplexer 100 may be configured to allow a user to configure and control the individual MFC units from a remote location.

Because it is a digital system, the MFC multiplexer 100 could be made to operate with other types of remote sensors, besides MFC energy harvesters, in some embodiments. As long as the remote sensors were able to communicate over the same communication protocol (e.g. RS-232) and had a need for their communication links to be isolated from one another, the MFC multiplexer 100 would be an appropriate solution.

FIG. 1C shows an exemplary illustration of a third embodiment for a MFC Multiplexer 100 comprising a platform 10, a plurality of wireless energy harvesters 21, and a MFC multiplexer 100, wherein the MFC Multiplexer 100 is wirelessly connected to the plurality of energy harvesters. Each of the plurality of energy harvesters may comprise a wireless transmitter and/or receiver to facilitate communication with the MFC multiplexer. A plurality of wireless energy harvesters 21 having a wireless connection may provide numerous benefits, including to facilitate wider dispersion of microbial fuel cells, for one example benefit.

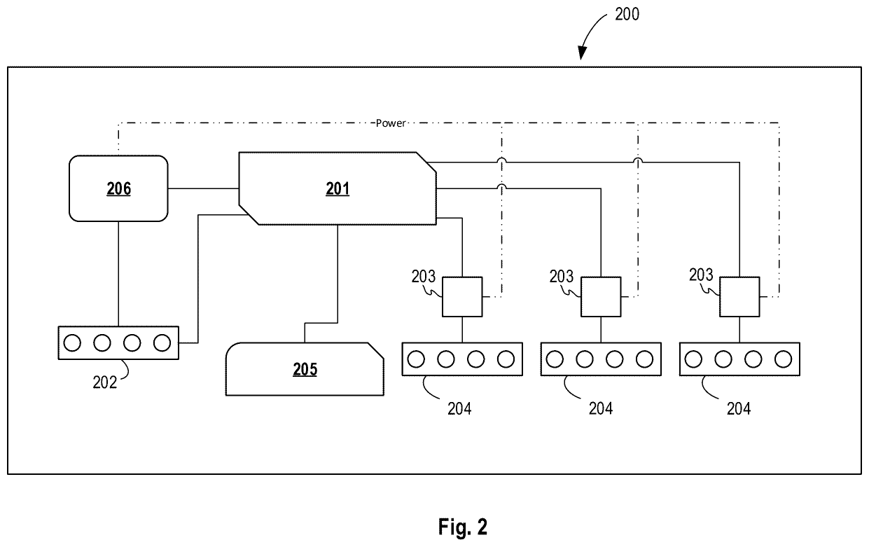

FIG. 2 shows an exemplary illustration of a printed circuit board (PCB) 200 for a MFC Multiplexer 100 comprising a microcontroller 201, a host port 202, plurality of isolator chips 203, and plurality of unit ports 204, header 205, and voltage regulator 206. The microcontroller 201 is connected to each of the isolator chips 203, which are each further connected to the unit ports 204. The unit ports 204 provide an electrical pathway to connect with a MFC or an MFC electronics unit. The connection may be selectively implemented by the user. The plurality of isolator chips 203 may also receive power from the voltage regulator 206. Finally, the host port 202 may be electrically connected to a host platform, wherein the host platform may provide a power source and an operating terminal. The host or platform 10 may facilitate control, configuration, and/or operation by a user.

The microcontroller 201 may be suitable for receiving information from a MFC electronics unit and reformatting the information according to a communications protocol, and may further comprise a processor and a non-transitory storage medium capable of storing machine-readable instructions. In the embodiment comprising MFC energy harvesters, the platform 10 requires the data to be in a specific format to be properly transmitted.

A non-transitory storage medium may include computer storage media in the form of volatile and/or nonvolatile memory. The memory may be removable, non-removable, or a combination thereof. Examples of hardware devices include solid-state memory, hard drives, optical-disc drives, etc. Processors read data from various entities such as memory or I/O components. Memory stores, among other data, one or more applications. The applications, when executed by the one or more processors, operate to perform functionality on the computing device. The applications may communicate with counterpart applications or services such as web services accessible via a network (not shown). For example, the applications may represent downloaded client-side applications that correspond to server-side services executing in a cloud. In some examples, aspects of the disclosure may distribute an application across a computing system, with server-side services executing in a cloud based on input and/or interaction received at client-side instances of the application. In other examples, application instances may be configured to communicate with data sources and other computing resources in a cloud during runtime, such as communicating with a cluster manager or health manager during a monitored upgrade or may share and/or aggregate data between client-side services and cloud services.

Furthermore, the microcontroller 201 may be capable of receiving sleep state instructions from the host. Sleep state instructions may comprise initiating or ceasing a sleep state status. The sleep status is a state of the MFC Multiplexer 100 designed to require less energy. This state may be useful while the MFC energy harvesters are logging data, and multiplexing is not needed. In another example, the MFC Multiplexer 100 may sleep while ascending or descending to likewise conserve energy.

The isolator chips 203 enable electric isolation each of the microbial fuel cells. This is important to the operation of the MFC units. In order to conserve power, the MFC Mux may be powered from the host. This means that the MFC Mux can be turned off or put into a sleep state while the MFC units are logging data. The MFC Mux will be “woken up” when the host tells it that it is ascending again.

In one embodiment, the MFC Multiplexer 100 may further comprise a port expansion chip to facilitate connections to a plurality of MFC energy harvesters. In FIG. 2, one embodiment of a MFC multiplexer is shown with 3 unit ports 204, but this disclosure is not so limited. The port expansion chip may facilitate additional connections.

The MFC Multiplexer 100 also comprises a communications protocol for data transmission. In a preferred embodiment, the communication protocol is Recommended Standard 232 (RS-232). The baud rates for this protocol has predefined and user configurable.

Additionally, the MFC Multiplexer 100 may be configured, via the microcontroller, 205 to synchronize a clock within of each of the plurality of MFCs. This is important because the clocks on each of the MFC units can drift over time. When deployed for long periods of time (months or years) the individual clocks will most likely be off by a matter of minutes or hours from each other. Periodic re-synchronization of the clocks during the deployment will correct this drift and provide more accurate data. Accordingly, inventors implemented a time synchronization capacity to the MFC Multiplexer 100 to enable accurate and successful data logging.

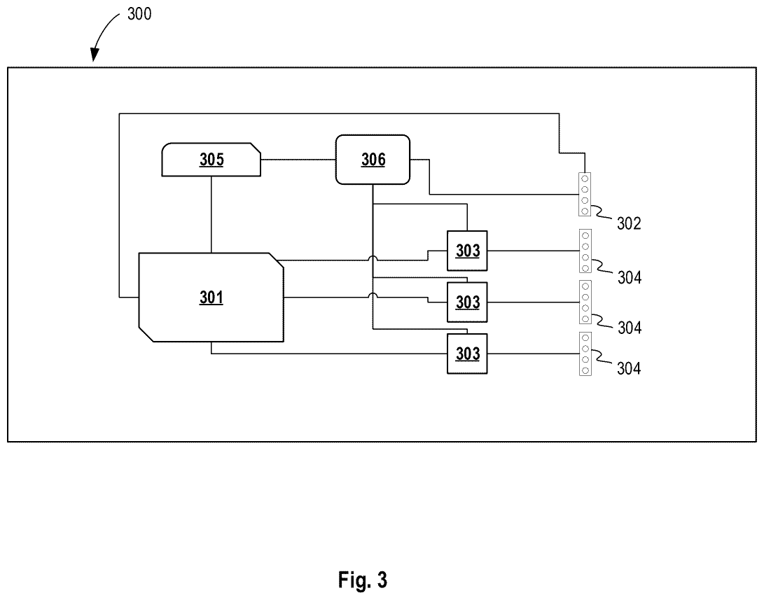

FIG. 3 shows a second exemplary illustration of a printed circuit board (PCB) 200 for a MFC Multiplexer 100 comprising a microcontroller 301, a host port 302, plurality of isolator chips 303, and plurality of unit ports 304, header 305, and voltage regulator 306. The features and functions discussed above similarly apply to this second PCB layout. Here, a compact and efficient layout is provided, optimized for construction and manufacturing.

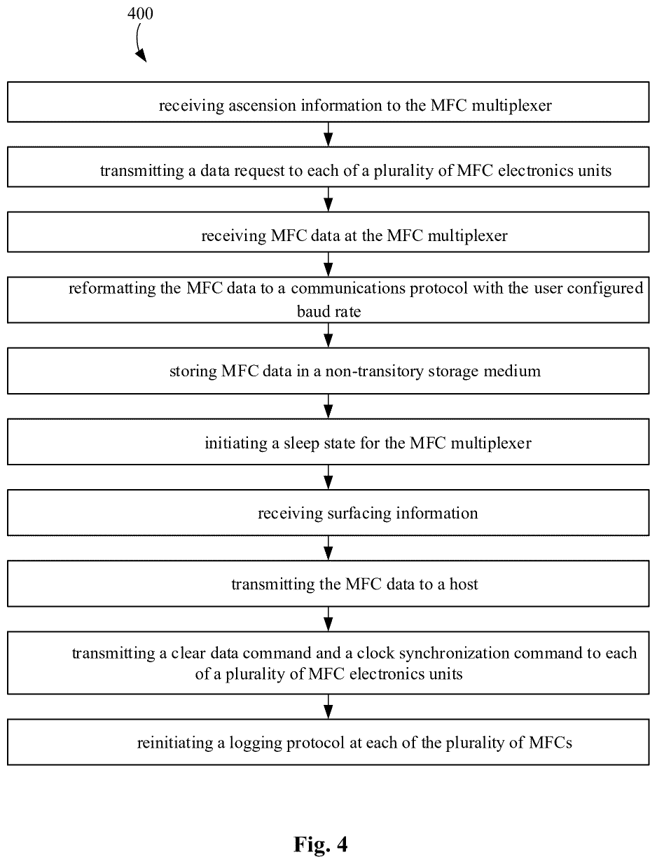

FIG. 4 shows a block-diagram illustration of a method for integrating a microbial fuel cell system having a MFC multiplexer 400, the steps comprising: receiving ascension information to the MFC multiplexer; transmitting a data request to each of a plurality of MFC electronics units; receiving MFC data at the MFC multiplexer; reformatting the MFC data to RS-232 format with the user configured baud rate; storing MFC data in a non-transitory storage medium; initiating a sleep state for the MFC multiplexer; receiving surfacing information; transmitting the MFC data to a host; transmitting a clear data command and a clock synchronization command to each of a plurality of MFC electronics units; and reinitiating a logging protocol at each of the plurality of MFCs.

Regarding the method described above, ascension information may comprise a command from the host to the platform to ascend. Similarly, the surface information may comprise a notification that the platform has surfaced. Additionally, the logging protocol is an issued instruction to the MFC electronics unit for the MFC energy harvesters to enter or reenter a logging state.

From the above description of Microbial Fuel Cell Multiplexer Apparatus, System, and Method, it is manifest that various techniques may be used for implementing the concepts of microbial fuel cell (MFC) multiplexer, integrated microbial fuel cell (MFC) and multiplexer system, and a method for integrating a microbial fuel cell system having a MFC multiplexer without departing from the scope of the claims. The described embodiments are to be considered in all respects as illustrative and not restrictive. The method/apparatus disclosed herein may be practiced in the absence of any element that is not specifically claimed and/or disclosed herein. It should also be understood that microbial fuel cell (MFC) multiplexer, integrated microbial fuel cell (MFC) and multiplexer system, and a method for integrating a microbial fuel cell system having a MFC multiplexer are not limited to the particular embodiments described herein, but is capable of many embodiments without departing from the scope of the claims.

What is claimed:

1. A microbial fuel cell (MFC) multiplexer, comprising:
a microcontroller suitable for receiving information from a plurality of MFC electronics units and reformatting the information according to a communications protocol, and further comprising a processor and a non-transitory storage medium capable of storing machine-readable instructions;
a host port connected to a host platform and electrically connected to the microcontroller, wherein the host platform provides a power source and an operating terminal;
a plurality of isolator chips electrically connected to the microcontroller, designed to electrically isolate a plurality of MFCs in a submerged environment; and
a plurality of unit ports, each electrically connected to one of the plurality of isolator chips, and arranged to selectively connect to each of the plurality of MFC electronics units.

2. The microbial fuel cell multiplexer of claim 1, further comprising a port expansion chip.

3. The microbial fuel cell multiplexer of claim 1, further comprising a voltage regulator.

4. The microbial fuel cell multiplexer of claim 1, wherein the communication protocol is Recommended Standard 232 with user configurable baud rates.

5. The microbial fuel cell multiplexer of claim 1, wherein the microcontroller is capable of receiving sleep state instructions from the host.

6. The microbial fuel cell multiplexer of claim 5, wherein the host transmits sleep state instructions before initiating ascension.

7. The microbial fuel cell multiplexer of claim 1, wherein the microcontroller is further configured to synchronize a clock within of each of the plurality of MFCs.

8. An integrated microbial fuel cell (MFC) and multiplexer system, comprising:
a plurality of microbial fuel cells (MFCs);
a plurality of MFC electronics units electrically connected to at least one of the plurality of MFCs;
a MFC multiplexer connected to each of the plurality of MFC electronics units, further comprising:
a microcontroller suitable for receiving information from plurality of MFC electronics units and reformatting the information according to a communications protocol, and further comprising a processor and a non-transitory storage medium capable of storing machine-readable instructions;
a host port connected to a host platform and electrically connected to the microcontroller, wherein the host platform provides a power source and an operating terminal;
a plurality of isolator chips, electrically connected to the microcontroller, designed to electrically isolate a plurality of MFCs; and
a plurality of unit ports, each electrically connected to one of the plurality of isolator chips, and arranged to selectively connect to each of the plurality of MFC electronics units.

9. The system for microbial fuel cell data collection of claim 8, further comprising a port expansion chip.

10. The system for microbial fuel cell data collection of claim 8, further comprising voltage regulator.

11. The system for microbial fuel cell data collection of claim 8, wherein the communication protocol is Recommended Standard 232 with user configurable baud rates.

12. The system for microbial fuel cell data collection of claim 8, wherein the microcontroller is capable of receiving sleep state instructions from the host.

13. The system for microbial fuel cell data collection of claim 8, wherein the microcontroller is further configured to synchronize a clock within of each of the plurality of MFCs.

14. A method for integrating a microbial fuel cell system having a MFC multiplexer, the steps comprising:
receiving ascension information to the MFC multiplexer;
transmitting a data request to each of a plurality of MFC electronics units;
receiving MFC data at the MFC multiplexer;
reformatting the MFC data to a communications protocol with the user configured baud rate;
storing MFC data in a non-transitory storage medium;
initiating a sleep state for the MFC multiplexer;
receiving surfacing information;
transmitting the MFC data to a host;
transmitting a clear data command and a clock synchronization command to each of a plurality of MFC electronics units; and
reinitiating a logging protocol at each of the plurality of MFCs.

15. The method for integrating a microbial fuel cell system having a MFC multiplexer of claim 14, wherein the MFC multiplexer further comprises a port expansion chip.

16. The method for integrating a microbial fuel cell system having a MFC multiplexer of claim 14, wherein the MFC multiplexer further comprises a voltage regulator.

17. The method for integrating a microbial fuel cell system having a MFC multiplexer of claim 14, wherein the communication protocol is Recommended Standard 232 with user configurable baud rates.

18. The method for integrating a microbial fuel cell system having a MFC multiplexer of claim 14, wherein the MFC multiplexer further comprises a microcontroller.

19. The method for integrating a microbial fuel cell system having a MFC multiplexer of claim 18, microcontroller is capable of receiving sleep state instructions from the host.

20. The method for integrating a microbial fuel cell system having a MFC multiplexer of claim 18, wherein the microcontroller is further configured to synchronize a clock within of each of the plurality of MFCs.
